(19) United States
(12) Patent Application Publication
(10) Pub. No.: US 2025/0088911 A1
(43) Pub. Date: Mar. 13, 2025

(54) DYNAMIC CAPACITY SCALING FOR WHITEBOX CORE NETWORKS

(71) Applicant: AT&T Intellectual Property I, L.P., Atlanta, GA (US)

(72) Inventor: Ambrin Zakaria, Milton, GA (US)

(21) Appl. No.: 18/463,251

(22) Filed: Sep. 7, 2023

(51) Int. Cl. H04W 28/24; H04W 28/08

(52) U.S. Cl. CPC H04W 28/24; H04W 28/095

(57) ABSTRACT

Devices, computer-readable media and methods are disclosed for dynamic capacity scaling for whitebox core networks. In one example, a method includes monitoring network traffic traversing a whitebox core network of a communications service provider, detecting a level of network traffic on a first link in the whitebox core network is greater than a threshold level of network traffic, and re-routing, in response to the detecting, at least one tunnel in the whitebox core network from the first link to a second link in the whitebox core network.

The present disclosure relates generally to telecommunication network operations, and relates more particularly to devices, computer-readable media, and methods for dynamic capacity scaling for whitebox core networks.

### BACKGROUND

Telecommunications network service providers have shifted in recent years toward the use of next-generation whitebox switches and routers to replace more traditional, dedicated core network infrastructure. Clusters of whitebox P-leaf routers, for instance, are capable of handling greater bandwidth than more traditional routers at a fraction of the cost.

### SUMMARY

Devices, computer-readable media, and methods are disclosed for dynamic capacity scaling for whitebox core networks. In one example, a method performed by a processing system including at least one processor includes monitoring network traffic traversing a whitebox core network of a communications service provider, detecting a level of network traffic on a first link in the whitebox core network is greater than a threshold level of network traffic, and re-routing, in response to the detecting, at least one tunnel in the whitebox core network from the first link to a second link in the whitebox core network.

In another example, a non-transitory computer-readable medium stores instructions which, when executed by a processing system including at least one processor, cause the processing system to perform operations. The operations include monitoring network traffic traversing a whitebox core network of a communications service provider, detecting a level of network traffic on a first link in the whitebox core network is greater than a threshold level of network traffic, and re-routing, in response to the detecting, at least one tunnel in the whitebox core network from the first link to a second link in the whitebox core network.

In another example, a system includes a processor and a non-transitory computer-readable medium storing instructions which, when executed by the processor, cause the processor to perform operations. The operations include monitoring network traffic traversing a whitebox core network of a communications service provider, detecting a level of network traffic on a first link in the whitebox core network is greater than a threshold level of network traffic, and re-routing, in response to the detecting, at least one tunnel in the whitebox core network from the first link to a second link in the whitebox core network.

### BRIEF DESCRIPTION OF THE DRAWINGS

The teaching of the present disclosure can be readily understood by considering the following detailed description in conjunction with the accompanying drawings, in which:

FIG. 1 illustrates an example system comprising a plurality of different networks in which examples of the present disclosure for dynamic capacity scaling for whitebox core networks may operate;

FIG. 2 illustrates a flowchart of an example method 200 for dynamically capacity scaling in a whitebox core network; and

FIG. 3 illustrates an example high-level block diagram of a computer specifically programmed to perform the steps, functions, blocks, and/or operations described herein.

To facilitate understanding, identical reference numerals have been used, where possible, to designate identical elements that are common to the figures.

### DETAILED DESCRIPTION

The present disclosure broadly discloses devices, computer-readable media, and methods for dynamic capacity scaling for whitebox core networks. As discussed above, telecommunications network service providers have shifted in recent years toward the use of next-generation whitebox switches and routers to replace more traditional, dedicated core network infrastructure. Clusters of whitebox P-leaf routers, for instance, are capable of handling greater bandwidth than more traditional core routers at a fraction of the cost.

However, most whitebox routers lack the ability to dynamically scale capacity in response to changing network conditions. Instead, traffic patterns in the core network are typically analyzed manually by (human) planning teams who decide when and where to add or remove infrastructure to scale capacity. As a result, the response time when addressing changing capacity needs may be too slow, resulting in failure to meet network demand and decreased user satisfaction.

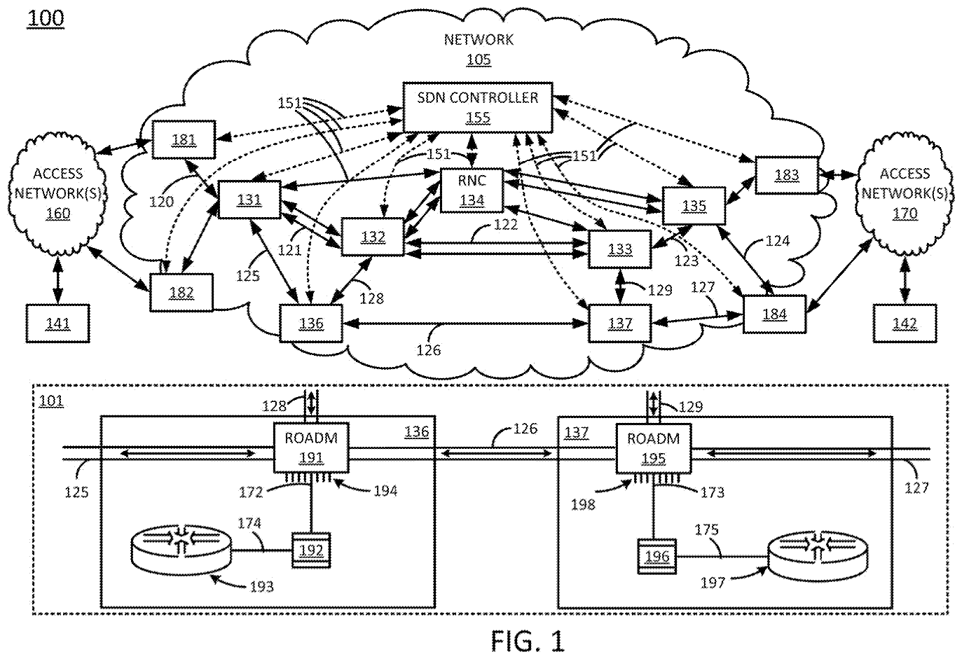

Examples of the present disclosure utilize a software defined networking-machine learning control algorithm that is capable of identifying and detecting long term shifts in core network traffic patterns. In response to detecting a long term shift in a core network traffic pattern, examples of the present disclosure may manage the centralized optimization of Layer 3 routing of tunnels by routing the tunnels away from congested links (and optionally applying differential treatment to prioritized network traffic). However, if even tunnel rerouting cannot mitigate the congestion (e.g., due to alternate paths being incapable of offering sufficient network capacity), examples of the present disclosure may in further examples direct a Layer 0 reconfigurable optical add drop multiplexer (ROADM) controller to add and/or delete wavelengths to adjust the capacity of the core network. Thus, the combined Layer 0 and Layer 3 control offers a flexible response to global traffic pattern shifts resulting from changes from content providers, seasonal spikes, and the like and improves the resiliency of the core network when responding to failure and congestion conditions. These and other aspects of the present disclosure are discussed in greater detail below in connection with the examples of FIGS. 1-3.

To aid in understanding the present disclosure, FIG. 1 illustrates an example system 100 comprising a plurality of different networks in which examples of the present disclosure for dynamic capacity scaling for whitebox core networks may operate. The overall communications system 100 may include any number of interconnected networks which may use the same or different communication technologies. As illustrated in FIG. 1, system 100 may include a network 105, e.g., a core telecommunication network. In one example, the network 105 may comprise a backbone network, or transport network, such as an Internet Protocol (IP)/Multi-Protocol Label Switching (MPLS) network, where label switched paths (LSPs) can be assigned for routing Transmission Control Protocol (TCP)/IP packets, User Datagram Protocol (UDP)/IP packets, and other types of protocol data units (PDUs) (broadly “traffic”). However, it will be appreciated that the present disclosure is equally applicable to other types of data units and network protocols. For instance, the network 105 may utilize IP routing (e.g., without MPLS). Furthermore, network 105 may comprise multiple networks utilizing different protocols, all utilizing a shared underlying WDM infrastructure (fibers, amplifiers, ROADMs, etc.), e.g., an optical transport network. In this regard, it should be noted that as referred to herein, “traffic” may comprise all or a portion of a transmission, e.g., a sequence or flow, comprising one or more packets, segments, datagrams, frames, cells, PDUs, service data units, bursts, and so forth. The particular terminology or types of data units involved may vary depending upon the underlying network technology. Thus, the term “traffic” is intended to refer to any quantity of data to be sent from a source to a destination through one or more networks.

In one example, the network 105 may be in communication with networks 160 and networks 170. Networks 160 and 170 may comprise wireless networks (e.g., Institute of Electrical and Electronics Engineers (IEEE) 802.11/Wi-Fi networks and the like), cellular access networks (e.g., Universal Terrestrial Radio Access Networks (UTRANs) or evolved UTRANs (eUTRANs), and the like), circuit switched networks (e.g., public switched telephone networks (PSTNs)), cable networks, digital subscriber line (DSL) networks, metropolitan area networks (MANs), Internet service provider (ISP) networks, peer networks, and the like. In one example, the networks 160 and 170 may include different types of networks. In another example, the networks 160 and 170 may be the same type of network. The networks 160 and 170 may be controlled or operated by a same entity as that of network 105 or may be controlled or operated by one or more different entities. In one example, the networks 160 and 170 may comprise separate domains, e.g., separate routing domains as compared to the network 105. In one example, networks 160 and/or networks 170 may represent the Internet in general.

In one example, network 105 may transport traffic to and from user devices 141 and 142. For instance, the traffic may relate to communications such as voice telephone calls, video and other multimedia, text messaging, emails, and so forth between the user devices 141 and 142, or between the user devices 141 and/or 142 and other devices that may be accessible via networks 160 and 170. User devices 141 and 142 may comprise, for example, cellular telephones, smart phones, personal computers, other wireless and wired computing devices, private branch exchanges, customer edge (CE) routers, media terminal adapters, cable boxes, home gateways and/or routers, and so forth.

As stated above, network 105 comprises a WDM network (e.g., a dense wavelength division multiplexing (DWDM) network). Accordingly, in one example, the nodes 131-137 may include optical components, such as reconfigurable add/drop multiplexers (ROADMs), and the links between nodes 131-137 may comprise fiber optic cables. Software-controlled ROADMs manage data traveling over high-capacity fiber optic lines and can automatically detect and adjust bandwidth, move traffic to different lanes, turn off wavelengths for a variety of different reasons, and so forth. Generally, each ROADM is connected to one or more other ROADMs by one or more optical fiber pairs. A given ROADM will transmit an optical signal on one fiber in a pair and receive a return signal on the other fiber in the pair; thus, each optical fiber transmits in a single direction. A Layer 1 service, or a wavelength, can then be set up between two transponders, where each transponder is connected to a nearby ROADM. The wavelength may then be routed through the ROADM network.

For ease of illustration, a portion of the links is specifically labeled as links 120-129. Inset 101 illustrates a portion of the network 105 comprising nodes 136 and 137, and links 125-129. As shown in inset 101, node 136 includes a ROADM 191 coupled to links 125, 126, and 128, a plurality of add/drop ports 194, and a router 193 coupled to the ROADM 191 via one of the plurality of add/drop ports 194 and a transponder 192 via a patch cord 172. Similarly, node 137 includes a ROADM 195 coupled to links 126, 127, and 129, a plurality of add/drop ports 198, and a network switch 197 coupled to ROADM 195 via a patch cord 173 between one of the plurality of add/drop ports 198, and a transponder 196.

In one example, one or both of the transponders 192 and 196 may comprise a muxponder that may aggregate several lower bandwidth signals from one or more network switches, routers, or other client devices at node 136 or node 137 into a combined signal for transmission over one of the network links 125, 126, 127, 128, or 129. In one example, one or both of the transponders 192 and 196 may be capable of transmitting and/or receiving optical signals for use in metro or transport applications at data rates of 100 Gb/s or greater. However, in another example, one or both of the transponders 192 and 196 may transmit and receive at lower data rates, such as 25 Gb/s, 10 Gb/s etc. ROADMs 191 and 195 may comprise colorless ROADMs, directionless ROADMs, colorless and directionless ROADMs (CD ROADMs), contentionless ROADMs, e.g., colorless, directionless, and contentionless (CDC) ROADMs, and so forth. Additionally, it should be noted that these ROADMs may include Open ROADMs with open standards allowing interoperability of different ROADMs manufactured by different vendors.

It should be noted that in each of nodes 136 and 137, any number of routers, switches, application servers, and the like may be connected to one of the plurality of add/drop ports 194 or plurality of add/drop ports 198, e.g., via additional transponders and/or transceivers. In addition, in other examples, additional components, such as additional ROADMs, may be connected to one of the plurality of add/drop ports 194 or plurality of add/drop ports 198. For instance, in another example, node 137 may include a number of ROADMs, wavelength selective switches (WSSs), and other components that are interconnected to provide a higher degree node. In addition, as referred to herein the terms “switch” and “network switch” may refer to any of a number of similar devices, e.g., including: a Layer 2 switch (e.g., an Ethernet switch), a Layer 3 switch/multi-layer switch, a router (e.g., a router which may also include switching functions), or the like. It should also be noted that nodes 131-135 may have a same or similar setup as nodes 136 and 137. In addition, in one example, any one or more of components 181-184 may also comprise an optical node with a same or similar setup as nodes 136 and 137. Any of the nodes 131-135 and components 181-184 may comprise a whitebox (e.g., P-leaf) router or a cluster of whitebox routers.

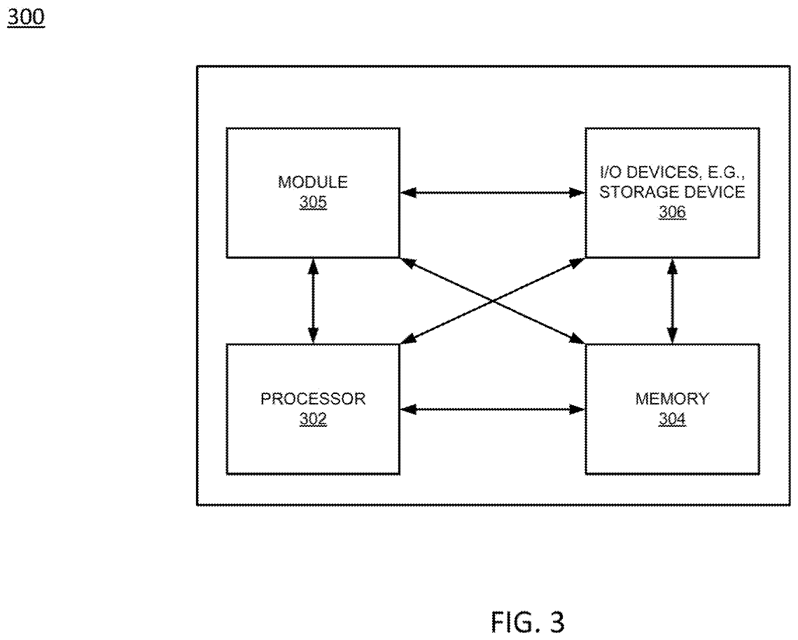

As further illustrated in FIG. 1, network 105 includes a software defined network (SDN) controller 155 and a ROADM network controller (RNC) 134. In one example, the SDN controller 155 may comprise a computing system or server, such as computing system 300 depicted in FIG. 3, and may be configured to provide one or more operations or functions for dynamic capacity scaling for whitebox core networks. In addition, it should be noted that as used herein, the terms “configure,” and “reconfigure” may refer to programming or loading a processing system with computer-readable/computer-executable instructions, code, and/or programs, e.g., in a distributed or non-distributed memory, which when executed by a processor, or processors, of the processing system within a same device or within distributed devices, may cause the processing system to perform various functions. Such terms may also encompass providing variables, data values, tables, objects, or other data structures or the like which may cause a processing system executing computer-readable instructions, code, and/or programs to function differently depending upon the values of the variables or other data structures that are provided. As referred to herein a “processing system” may comprise a computing device including one or more processors, or cores (e.g., a computing system as illustrated in FIG. 3 and discussed below) or multiple computing devices collectively configured to perform various steps, functions, and/or operations in accordance with the present disclosure. In addition, with respect to ROADMs, “configured” and “reconfigured” may refer to instructions to adjust a wavelength selective switch (WSS) to route different wavelengths to different fibers/links and/or to different add/drop ports. With respect to network switches and transponders, “configured” and “reconfigured” may refer to instructions to send or receive at a particular bitrate, to utilize a particular transmit power, to transmit or receive on a particular wavelength, and the like.

In one example, nodes 131-137 and components 181-184 (and/or the devices therein) may be controlled and managed by SDN controller 155. For instance, in one example, SDN controller 155 is responsible for such functions as provisioning and releasing instantiations of virtual network functions (VNFs) to perform the functions of routers, switches, and other devices, provisioning routing tables and other operating parameters for the VNFs, and so forth. Thus, various components of network 105 may comprise virtual network functions which may physically comprise hardware executing computer-readable/computer-executable instructions, code, and/or programs to perform various functions. For example, the functions of SDN controller 155 may include the selection of a network function virtualization infrastructure (NFVI) from among various NFVIs available at nodes 131-137 in network 105 to host various devices, such as routers, gateways, switches, route reflectors, firewalls, media servers, and so forth. To illustrate, network switches 193 and 197 may physically reside on host devices that may be configured to be a firewall, a media server, a network switch, a router, and so forth.

In addition, SDN controller 155 may also manage the operations of optical components of the network 105. For instance, SDN controller 155 may configure paths for wavelength connections via the network 105 by configuring and reconfiguring ROADMs at nodes 131-137 and components 181-184. For example, SDN controller 155 may provide instructions to control WSSs within the ROADMs, as well as transceivers and/or transponders connected to the ROADM add/drop ports. In one example, SDN controller 155 may maintain communications with nodes 131-137 and components 181-184 (and/or the devices therein) via a number of control links 151 which may comprise secure tunnels for signaling communications over an underling IP infrastructure of network 105, e.g., including fibers/links 120-129, etc. In other words, the control links 151 may comprise virtual links multiplexed with transmission traffic and other data traversing network 105 and carried over a shared set of physical links. Alternatively, or in addition, the control links 151 may comprise out-of-band links, e.g., optical or non-optical connections that are different from fibers/links 120-129.

In one example, SDN controller 155 may be in communication with the RNC 134. For example, RNC 134 may be responsible for instantiating and releasing instances of virtual machines at nodes 131-137 and for configuring and reconfiguring operations of associated ROADMs, such as ROADMs 191 and 195, transponders 192 and 196, and other devices at the nodes 131-137 such as transceivers, network switches, and so on. Alternatively, the RNC may control respective node controllers at the nodes 131-137 to instantiate and release instances of virtual machines and to configure and reconfigure devices at the nodes 131-137. Thus, in one example, RNC 134 may receive instructions for configuring and reconfiguring ROADMs 191 and 195 from SDN controller 155, e.g., via control links 151. Alternatively, or in addition, control links 151 may provide connections between SDN controller 155 and ROADMs 191 and 195, transponders 192 and 196, and other devices at the nodes such as transceivers and network switches without the involvement of the RNC 134 and/or individual node controllers. In one example, the SDN controller 155 may also comprise a virtual machine operating on one or more NFVI/host devices, or may comprise one or more dedicated devices. For instance, SDN controller 155 may be collocated with one or more VNFs, may be deployed in one or more different host devices, or at a different physical location or locations, and so forth.

In addition, in one example, SDN controller 155 may represent a processing system comprising a plurality of controllers, e.g., a multi-layer SDN controller, one or more federated Layer 0/physical layer SDN controllers, and so forth. For instance, a multi-layer SDN controller may be responsible for instantiating, tearing down, configuring, reconfiguring, and/or managing Layer 2 and/or Layer 3 VNFs (e.g., a network switch, a Layer 3 switch and/or a router, etc.), whereas one or more Layer 0 SDN controllers may be responsible for activating and deactivating optical networking components, for configuring and reconfiguring the optical networking components (e.g., to provide circuits/wavelength connections between various nodes or to be placed in idle mode), for receiving management and configuration information from such devices, for instructing optical devices at various nodes to provision optical network paths in accordance with the present disclosure, and so forth. In one example, the Layer 0 SDN controller(s) may in turn be controlled by the multi-layer SDN controller. For instance, each Layer 0 SDN controller may be assigned to nodes/optical components within a portion of the network 105. In addition, these various components may be co-located or distributed among a plurality of different dedicated computing devices or shared computing devices (e.g., NFVI) as described herein.

In one example, the SDN controller 155 may be configured to perform operations in connection with examples of the present disclosure for dynamic capacity scaling for whitebox core networks. For instance, in one example, the SDN controller 155 may monitor the network traffic traversing the nodes 131-137, components 181-184, and links 120-129 of the network 105. In the event that the SDN controller 155 detects that a level of network traffic on any of the links 120-129 exceeds a threshold level of network traffic, the SDN controller 155 may take remediating action to alleviate congestion on those links 120-129. The remediating action may include one or more actions intended to reduce the level of network traffic on the congested link(s) 120-129 to less than the threshold level.

For instance, in one example, the SDN controller 155 may re-route at least one MPLS traffic engineering (TE) tunnel from a first link 120-129 (on which the level of network traffic exceeds the threshold level of network traffic) to a second link 120-129 (on which the level of network traffic is below the threshold level of network traffic). If, however, the level of network traffic on the first link still exceeds the threshold level of network traffic even after re-routing the tunnel (or if no other links 120-129 have sufficient capacity to support re-routing of the tunnel), then the SDN controller 155 may take further remediating action.

In one example, the further remediating action may comprise sending an instruction to the RNC 134 to adjust a wavelength allocation of at least one ROADM (e.g., ROADM 191 or 195). Adjusting the wavelength allocation may involve adding or deleting wavelengths to scale the capacity of the network 105. In one example, the SDN controller 155 (or the SDN controller 155 in conjunction with the RNC 134) may identify Layer 3 wavelength bundles that would be capable of alleviating congestion due to network traffic if augmented with additional capacity (e.g., additional wavelengths). For instance, the RNC 134 may dynamically provision a new Layer 0 wavelength with which to augment an existing bundle of wavelengths. In this case, a spare router side tail (e.g., side tail 174 of router 193 in FIG. 1 or side tail 175 of router 197 in FIG. 1) may be used to connect a Layer 3 router port (e.g., of router 193 or 197) to a Layer 0 transponder port (e.g., of transponder 192 or 196) connected to a ROADM (e.g., ROADM 191 or 195) in order to augment an existing bundle of wavelengths with the provisioned new wavelength. Spare router side tails, such as side tails 174 and 175, may be deployed in strategic locations based on knowledge of long-term network traffic patterns, in order to provide a means of increasing network capacity in the locations that are expected to be most in need of increased capacity at various times.

In some examples, the SDN controller 155 may learn over time that the network traffic on certain links 120-129 follows expected long-term patterns. For instance, the SDN controller 155 may execute a machine learning algorithm (e.g., a support vector machine, a neural network, a linear regression algorithm, a decision tree, a naïve Bayes algorithm, or the like) that has been trained to detect when conditions in the whitebox core network are likely to indicate a situation in which the level of network traffic on one or more links will exceed the threshold level of network traffic. As an example, the machine learning algorithm may learn that the network traffic on certain links 120-129 may be more likely to exceed the threshold level of network traffic at specific times of day, during specific times of the year, or during specific types of events (e.g., holidays, global sporting events, etc.). In these cases, the SDN controller 155 may take any of the actions discussed above prior to actually detecting the level of network traffic on any link 120-129 exceeding the threshold level (e.g., in anticipation of the threshold level being exceeded within some threshold window of time in the future).

Furthermore, in some examples, the SDN controller 155 may learn based on these long-term patterns that certain remediating actions may be insufficient to alleviate congestion on certain links 120-129, and may take action accordingly. For instance, the SDN controller 155 may learn that during a certain global sporting event, re-routing tunnels among the links 120-129 is not enough to ensure that the level of network traffic on all links is below the threshold level. In such an instance, when the global sporting event recurs (or just prior to the global sporting event recurring), the SDN controller 155 may not attempt to re-route tunnels at all before instructing the RNC 134 to adjust the wavelength allocations.

It should be noted that the system 100 has been simplified. In other words, the system 100 may be implemented in a different form than that illustrated in FIG. 1. For example, the system 100 may be expanded to include additional networks and additional network elements (not shown) such as border elements, routers, switches, policy servers, security devices, gateways, a content distribution network (CDN) and the like, without altering the scope of the present disclosure. In addition, system 100 may be altered to omit various elements, substitute elements for devices that perform the same or similar functions and/or combine elements that are illustrated as separate devices. For example, SDN controller 155, RNC 134, and/or other network elements may comprise functions that are spread across several devices that operate collectively as a SDN controller, an RNC, etc. In another example, RNC 134 and SDN controller 155 may be integrated into a single device. In another example, RNC 134 may maintain its own connections to nodes 131-137 and components 181-184 and may send instructions to various devices to dynamically scale the capacity of the network 105 in accordance with the present disclosure. In another example, nodes 131-137 and/or components 181-184 may include fiber loss test sets (FLTSs), optical time domain reflectometers (OTDRs), polarization mode dispersion (PMD) measurement devices, and the like which may be used to measure fiber loss and PMD over various links.

In addition, the foregoing includes examples where operations for dynamic capacity scaling for whitebox core networks are performed by RNC 134, and/or by RNC 134 in conjunction with other devices under the control and instruction of SDN controller 155. However, in other, further, and different examples, aspects of dynamic capacity scaling may include transponders and/or network switches performing one or more operations autonomously. Thus, these and other modifications of the system 100 are all contemplated within the scope of the present disclosure.

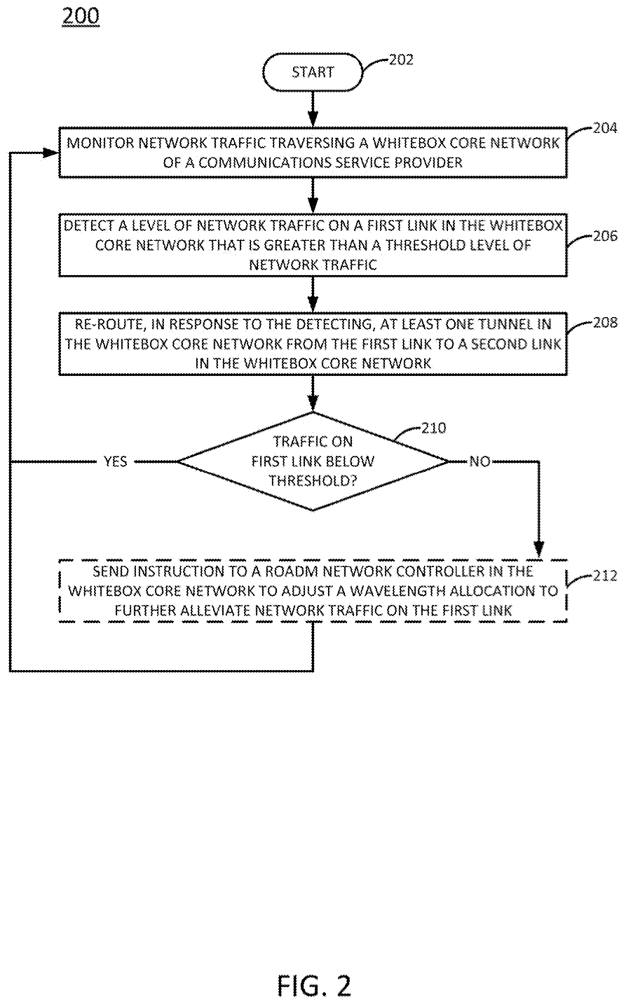

FIG. 2 illustrates a flowchart of an example method 200 for dynamically capacity scaling in a whitebox core network. In one example, steps, functions and/or operations of the method 200 may be performed by a network-based device, such as SDN controller 155 in FIG. 1, or any one or more components thereof, such as a processing system. Alternatively, or in addition, the steps, functions and/or operations of the method 200 may be performed by a processing system collectively comprising a plurality of devices as illustrated in FIG. 1, such as SDN controller 155, RNC 134, ROADM 191 and/or ROADM 195, and/or transponders 192 and 196, and so forth. In one example, the steps, functions, or operations of method 200 may be performed by a computing device or system 300, and/or a processing system 302 as described in connection with FIG. 3 below. For illustrative purposes, the method 200 is described in greater detail below in connection with an example performed by a processing system, such as processing system 302.

The method 200 begins in step 202. In step 204, the processing system may monitor network traffic traversing a whitebox core network of a communications service provider.

As discussed above, a whitebox core network is a core network in which next-generation whitebox switches and routers replace more traditional, dedicated core network infrastructure. In one example, the whitebox core network is an IP-MPLS network. The topology of the whitebox core network may generally comprise a plurality of network elements, such as switches and routers, which are connected by a plurality of links.

It may be determined (e.g., through machine learning and/or observation of historical traffic patterns), what the maximum levels of network traffic are that can be supported by the topology of the whitebox core network without negatively impacting customer experience (e.g., where negatively impacting customer experience may comprise a failure to meet one or more customer experience targets). Thus, in step 204, the processing system may monitor the network traffic in order to determine a current level of the network traffic (e.g., low, high, average, etc.).

In step 206, the processing system may detect a level of network traffic on a first link in the whitebox core network is greater than a threshold level of network traffic.

In one example, the level of network traffic may be quantified in some metric, such as packet loss (e.g., where different numbers of or percentages of lost packets are correlated with different levels of network traffic), number of packets traversing the first link (e.g., where different numbers of packets are correlated with different levels of network traffic), sizes of packets traversing the first link (e.g., where different average, maximum, or other sizes of packets may be correlated with different levels of network traffic), a combination of two or more of these metrics, or the like.

In one example, the threshold level of network traffic may comprise a predefined level of network traffic, as discussed above, the threshold level of network traffic may be determined and set empirically based on observation of historical traffic patterns and the impacts of these historical traffic patterns on customer experience. When a detected or observed level of network traffic on the first link is at or below the predefined level of network traffic, an operator of the whitebox core network may expect to meet customer experience targets; however, when a detected or observed level of network traffic on the first link is above the predefined level of network traffic, the operator of the whitebox core network may expect to fall short of those customer experience targets. In one example, different threshold levels of network traffic may be associated with different links of the whitebox core network. That is, the threshold level of network traffic may not be equal or identical for all links, and each link may be monitored with respect to its respective threshold level of network traffic.

In step 208, the processing system may re-route, in response to the detecting, at least one tunnel in the whitebox core network from the first link to a second link in the whitebox core network.

In one example, the at least one tunnel may comprise a Layer 3 MPLS traffic engineering (TE) tunnel. In one example, the second link may be a link for which the current or observed level of network traffic is below the threshold level of network traffic (e.g., for the links collectively or for the second link specifically). Moreover, in one example, re-routing the at least one tunnel to the second link should not be expected to result in the level of network traffic on the second link exceeding the threshold level of network traffic. That is, the second link should be selected such that the re-routing does not create a need to subsequently re-route one or more tunnels from the second link to a third link.

In one example, re-routing may optionally apply differentiated treatment to prioritized network traffic. For instance, certain classes of network traffic (e.g., traffic carrying streaming media, medical or emergency services data, or data from user endpoints that are subscribed to certain service tiers) may be guaranteed a higher quality of service than other classes of network traffic. In this case, if the network traffic traversing the at least one tunnel comprises a prioritized class of network traffic, then the selection of the second link from among other candidate links in the whitebox core network may be influenced by the class of the network traffic traversing the at least one tunnel (e.g., the second link may be best suited among the candidate links to ensure continued treatment of the network traffic at the guaranteed quality of service).

In step 210, the processing system may determine, after the re-routing, whether the level of network traffic on the first link is below the threshold level of network traffic.

Thus, the processing system may determine whether the re-routing of the at least one tunnel was successful in alleviating the congestion on the first link. In some cases, simply re-routing the at least one tunnel may be sufficient to alleviate the congestion (i.e., to reduce the level of network traffic on the first link to below the threshold level of network traffic). However, in other cases, even re-routing the at least one tunnel may not be sufficient to alleviate the network traffic (or no other links in the whitebox core network may be available to accept re-routing of the at least one tunnel without exceeding the threshold level of network traffic), in which case further measures may be necessary.

If the processing system concludes in step 210 that the level of network traffic on the first link is now below the threshold level of network traffic, then the method 200 may return to step 204, and the processing system may continue as described above to monitor the network traffic traversing the whitebox core network.

Thus, the processing system may continuously monitor for levels of network traffic traversing the whitebox core network which exceed the threshold level of network traffic (e.g., to detect any links that become congested). As discussed above, the threshold level of network traffic may not necessarily be the same for all links in the whitebox core network. For instance, some links may be capable of handling higher levels of network traffic than other links without falling short of customer experience targets. In such cases, links that are capable of handling higher levels of network traffic may be assigned higher threshold levels of network traffic for the purposes of dynamic capacity scaling in accordance with the method 200.

If, however, the processing system concludes in step 210 that the level of network traffic on the first link is still not below the threshold level of network traffic (or no other links in the whitebox core network may be available to accept re-routing of the at least one tunnel without exceeding the threshold level of network traffic), then the method 200 may proceed to step 212.

In optional step 212 (illustrated in phantom), the processing system may send an instruction to a reconfigurable add/drop multiplexer (ROADM) network controller in the whitebox core network to adjust a wavelength allocation to further alleviate network traffic on the first link.

In one example, adjusting a wavelength allocation may comprise adding or deleting a wavelength in a Layer 0 ROADM. In one example, the processing system may identify a Layer 3 bundle of wavelengths that would be capable of alleviating congestion due to network traffic if augmented with additional capacity (e.g., additional wavelengths). The processing system may then dynamically provision a new Layer 0 wavelength with which to augment an existing bundle of wavelengths. In this case, a spare router side tail may be used to connect a Layer 3 router port to a Layer 0 transponder port connected to a ROADM in order to augment an existing bundle of wavelengths with the provisioned new wavelength. Spare router side tails may be deployed in strategic locations based on knowledge of long-term network traffic patterns, in order to provide a means of increasing network capacity in the locations that are expected to be most in need of increased capacity at various times.

Thus, step 212 may represent a backup measure in the event that the re-routing of step 208 cannot adequately alleviate the congestion on the first link. For instance, if alternate links are at or near their respective threshold levels of network traffic, then re-routing the at least one tunnel to one or more of those alternate links may only create a situation in which the threshold level of network traffic is exceeded on a different link.

It should be noted that in some cases, the method 200 may skip over steps 208-210 and proceed directly from step 206 to step 212. For instance, over time, the processing system may learn certain long-term patterns in levels of network traffic that are indicative of congestion conditions which cannot be alleviated by re-routing tunnels (e.g., conditions that always require step 212 to be performed). When the processing system detects a level of network traffic in step 206 that may be indicative of one of these long-term patterns, the processing system may automatically and immediately proceed to send instructions to the ROADM network controller in order to more efficiently alleviate the congestion.

The method 200 may then return to step 204, and the processing system may continue as described above to monitor the network traffic traversing the whitebox core network.

The method 200 thereby combines control of Layer 0 and Layer 3 network elements to flexibly respond to global traffic pattern shifts (e.g., due to changes on content provider services, seasonal spikes, or the like) in a whitebox core network in real time. As a result, congestion and other failure conditions may be resolved before the effects of those conditions can negatively impact customer experience.

It should be noted that the method 200 may be expanded to include additional steps or may be modified to include additional operations with respect to the steps outlined above. For instance, as discussed above, certain steps of the method 200 could be skipped as more information on long-term network traffic patterns in the whitebox core network becomes available. In addition, although not specifically specified, one or more steps, functions, or operations of the method 200 may include a storing, displaying, and/or outputting step as required for a particular application. In other words, any data, records, fields, and/or intermediate results discussed in the method can be stored, displayed, and/or outputted either on the device executing the method or to another device, as required for a particular application. Furthermore, steps, blocks, functions or operations in FIG. 2 that recite a determining operation or involve a decision do not necessarily require that both branches of the determining operation be practiced. In other words, one of the branches of the determining operation can be deemed as an optional step. Furthermore, steps, blocks, functions or operations of the above described method can be combined, separated, and/or performed in a different order from that described above, without departing from the examples of the present disclosure.

FIG. 3 depicts a high-level block diagram of a computing device or processing system specifically programmed to perform the functions described herein. As depicted in FIG. 3, the processing system 300 comprises one or more hardware processor elements 302 (e.g., a central processing unit (CPU), a microprocessor, or a multi-core processor), a memory 304 (e.g., random access memory (RAM) and/or read only memory (ROM)), a module 305 for dynamic capacity scaling for whitebox core networks, and various input/output devices 306 (e.g., storage devices, including but not limited to, a tape drive, a floppy drive, a hard disk drive or a compact disk drive, a receiver, a transmitter, a speaker, a display, a speech synthesizer, an output port, an input port and a user input device (such as a keyboard, a keypad, a mouse, a microphone and the like)). In accordance with the present disclosure input/output devices 306 may also include antenna elements, transceivers, power units, and so forth. Although only one processor element is shown, it should be noted that the computing device may employ a plurality of processor elements. Furthermore, although only one computing device is shown in the figure, if the method 200 as discussed above is implemented in a distributed or parallel manner for a particular illustrative example, i.e., the steps of the above method 200, or the entire method 200 is implemented across multiple or parallel computing devices, e.g., a processing system, then the computing device of this figure is intended to represent each of those multiple computing devices.

Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented. The hardware processor 302 can also be configured or programmed to cause other devices to perform one or more operations as discussed above. In other words, the hardware processor 302 may serve the function of a central controller directing other devices to perform the one or more operations as discussed above.

It should be noted that the present disclosure can be implemented in software and/or in a combination of software and hardware, e.g., using application specific integrated circuits (ASIC), a programmable gate array (PGA) including a Field PGA, or a state machine deployed on a hardware device, a computing device or any other hardware equivalents, e.g., computer readable instructions pertaining to the methods discussed above can be used to configure a hardware processor to perform the steps, functions and/or operations of the above disclosed method 200. In one example, instructions and data for the present module or process 305 for dynamic capacity scaling for whitebox core networks (e.g., a software program comprising computer-executable instructions) can be loaded into memory 304 and executed by hardware processor element 302 to implement the steps, functions, or operations as discussed above in connection with the illustrative method 200. Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method(s) can be perceived as a programmed processor or a specialized processor. As such, the present module 305 for dynamic capacity scaling for whitebox core networks (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette, and the like. Furthermore, a “tangible” computer-readable storage device or medium comprises a physical device, a hardware device, or a device that is discernible by the touch. More specifically, the computer-readable storage device may comprise any physical devices that provide the ability to store information such as data and/or instructions to be accessed by a processor or a computing device such as a computer or an application server.

While various examples have been described above, it should be understood that they have been presented by way of illustration only, and not a limitation. Thus, the breadth and scope of any aspect of the present disclosure should not be limited by any of the above-described examples, but should be defined only in accordance with the following claims and their equivalents.

What is claimed is:

1. A method comprising:
monitoring, by a processing system including at least one processor, network traffic traversing a whitebox core network of a communications service provider;
detecting, by the processing system, a level of network traffic on a first link in the whitebox core network is greater than a threshold level of network traffic; and
re-routing, by the processing system in response to the detecting, at least one tunnel in the whitebox core network from the first link to a second link in the whitebox core network.

2. The method of claim 1, wherein the whitebox core network is an internet protocol-multiprotocol label switching network.

3. The method of claim 1, wherein the threshold level of network traffic is the same for both the first link and the second link.

4. The method of claim 1, wherein the threshold level of network traffic is different for the first link and the second link.

5. The method of claim 1, wherein the threshold level of network traffic is determined empirically based on an observation of historical traffic patterns in the whitebox core network and impacts of the historical traffic patterns on customer experience.

6. The method of claim 5, wherein the threshold level of network traffic comprises a level of network traffic that, if exceeded on the first link, is expected to result in a failure to meet a customer experience target of the whitebox core network.

7. The method of claim 1, wherein the threshold level of network traffic is quantified as at least one of: a packet loss on the first link, a number of packets traversing the first link, or sizes of packets traversing the first link.

8. The method of claim 1, wherein the at least one tunnel comprises a layer 3 multiprotocol label switching-traffic engineering tunnel.

9. The method of claim 1, wherein the second link comprises a link in the whitebox core network for which the threshold level of network traffic is not expected to be exceeded after the at least one tunnel is re-routed to the second link.

10. The method of claim 1, further comprising:
determining, by the processing system after the re-routing, that the level of network traffic on the first link is still greater than the threshold level of network traffic; and
sending, by the processing system, an instruction to a reconfigurable add/drop multiplexer network controller in the whitebox core network to adjust a wavelength allocation to further alleviate network traffic on the first link.

11. The method of claim 10, wherein the adjusting the wavelength allocation comprises augmenting a bundle of wavelengths associated with a layer 0 reconfigurable add/drop multiplexer of the whitebox core network with a new wavelength.

12. The method of claim 11, wherein the processing system dynamically provisions the new wavelength.

13. The method of claim 12, wherein a spare router side tail of a router of the whitebox core network is used to connect a layer 3 port of the router to a layer 0 port of a transponder connected to the layer 0 reconfigurable add/drop multiplexer in order to augment the bundle of wavelengths.

14. The method of claim 13, wherein the spare router side tail is deployed in a location of the whitebox core network that is expected, based on an analysis of historical network traffic patterns in the whitebox core network, to be in need of increased capacity.

15. The method of claim 1, wherein the monitoring is performed continuously.

16. The method of claim 15, further comprising:
repeating the re-routing from a third link in the whitebox core network to a fourth link in the whitebox core network when a repetition of the detecting detects a level of network traffic on the third link that is greater than the threshold level of network traffic.

17. The method of claim 1, wherein a selection of the second link from among other links in the whitebox core network is influenced by a prioritized class of the network traffic traversing the at least one tunnel.

18. The method of claim 1, wherein the processing system is part of a software defined networking controller that is in communication with nodes and components of the whitebox core network.

19. A non-transitory computer-readable medium storing instructions which, when executed by a processing system including at least one processor, cause the processing system to perform operations, the operations comprising:
monitoring network traffic traversing a whitebox core network of a communications service provider;
detecting a level of network traffic on a first link in the whitebox core network is greater than a threshold level of network traffic; and
re-routing, in response to the detecting, at least one tunnel in the whitebox core network from the first link to a second link in the whitebox core network.

20. A system comprising:
a processor; and
a non-transitory computer-readable medium storing instructions which, when executed by the processor, cause the processor to perform operations, the operations comprising:
monitoring network traffic traversing a whitebox core network of a communications service provider;
detecting a level of network traffic on a first link in the whitebox core network is greater than a threshold level of network traffic; and
re-routing, in response to the detecting, at least one tunnel in the whitebox core network from the first link to a second link in the whitebox core network.
